(19) United States
(12) Patent Application Publication
(10) Pub. No.: US 2002/0181244 A1
(43) Pub. Date: Dec. 5, 2002

(54) Vehicle headlamp system

(76) Inventor: John T. Griffin, Waltham, MA (US)

Correspondence Address: NIXON PEABODY, LLP, 8180 GREENSBORO DRIVE, SUITE 800, MCLEAN, VA, 22102, US

(21) Appl. No.: 10/200,430

(22) Filed: Jul. 23, 2002

Related U.S. Application Data
(63) Continuation-in-part of application No. 09/764,278, filed on Jan. 19, 2001, now Pat. No. 6,462,479.

(51) Int. Cl. B60Q 1/05; F21V 21/26

(52) U.S. Cl. 362/527; 362/509; 362/543; 362/286; 362/272

(57) ABSTRACT

A headlamp system for a motor vehicle for providing increased visibility to a driver of the vehicle when the vehicle is in a moisture-laden atmosphere. The system includes at least one headlamp adapted to produce a beam of illuminating light and a shield mounted for placement adjacent to said at least one headlamp. The headlamp is selectively movable between a first position in which it is recessed into the body of the vehicle and a second position in which it projects in front of the body of the vehicle to permit the shield to deflect at least a portion of the beam of illuminating light emitted.

This application is a continuation-in-part of application Ser. No. 09/764,278 filed Jan. 19, 2001.

### BACKGROUND OF THE INVENTION

1. Field of the Invention

This invention is related to the field of headlight systems for vehicles. More specifically, this invention is directed to a vehicle headlight system that improves visibility from the vehicle.

2. Description of the Related Art

Conventional vehicle headlight systems include a variety of headlights that each provides similar amounts of illumination. When such a vehicle encounters reduced visibility conditions, such as in fog, the driver of a vehicle may only adjust the brightness of the entire headlight system.

Some conventional vehicle headlight systems include “fog lamps” that are positioned generally lower on the vehicle than the corresponding set of headlamps. Presumably, moving the source of illumination to a lower position reduces the amount of glare that a driver experiences when faced with fog or other conditions of reduced visibility. However, all of the conventional vehicle headlight systems place the source of illumination directly in front of the driver.

### SUMMARY OF THE INVENTION

The inventor of the present invention discovered that a source of light that is offset from the line of sight a driver provides increased visibility when compared to a light that is positioned substantially directly along the line of sight of a driver in reduced visibility conditions. The present invention provides a headlamp system for a vehicle where the majority of the illumination power is shifted transversely away from the line of sight of a driver. In accordance with one embodiment of the present invention, a dual headlamp system of a conventional motor vehicle includes the ability to reduce the illumination of a driver side headlamp to reduce the amount of light being reflected back at the driver while maintaining the degree of illumination provided by the passenger side headlamp.

Another embodiment of the invention includes a retractable passenger-side headlamp for use in combination with a fixed shield that serves to increase the intensity of illumination of the headlamp system when the vehicle is operated in reduced visibility conditions. The fixed shield may be provided with a reflective surface that reflects the illumination of the light beam away from the driver-side of the vehicle and towards the roadway and the passenger-side area of the roadway. Yet and still another embodiment of the invention includes a passenger-side headlamp that is selectively reoriented so as to change the pattern of the beam of illuminating light from a horizontal geometric pattern to a vertical geometric pattern

### BRIEF DESCRIPTION OF THE DRAWINGS

The exemplary embodiments of this invention will be described in detail, with reference to the following figures, wherein:

FIG. 1 is a schematic view of light rays being scattered by drops of moisture in an atmosphere;

FIG. 2 is a schematic diagram of a simple conventional headlamp system;

FIG. 3 is a schematic diagram of one embodiment of a headlamp system in accordance with the present invention;

FIG. 4 shows a schematic overhead view of a vehicle incorporating an exemplary embodiment of a headlamp system in accordance with the invention;

FIG. 5 shows a perspective view of an motor vehicle provided with a retractable passenger-side headlamp and a fixed shield in accordance with the invention;

FIG. 6 shows a perspective view of the retractable headlamp and a fixed shield for a headlamp system in accordance with the invention;

FIG. 7 shows a side view of the retractable headlamp and fixed shield including a light distribution relationship with the passenger-side headlamp;

FIG. 8 shows a perspective view of a carrier mechanism for the retractable and the reorientable headlamp; and

FIG. 9 shows a perspective view of a motor vehicle provided with a headlamp system including a selectively reorientable passenger-side headlamp.

### DETAILED DESCRIPTION OF THE INVENTION

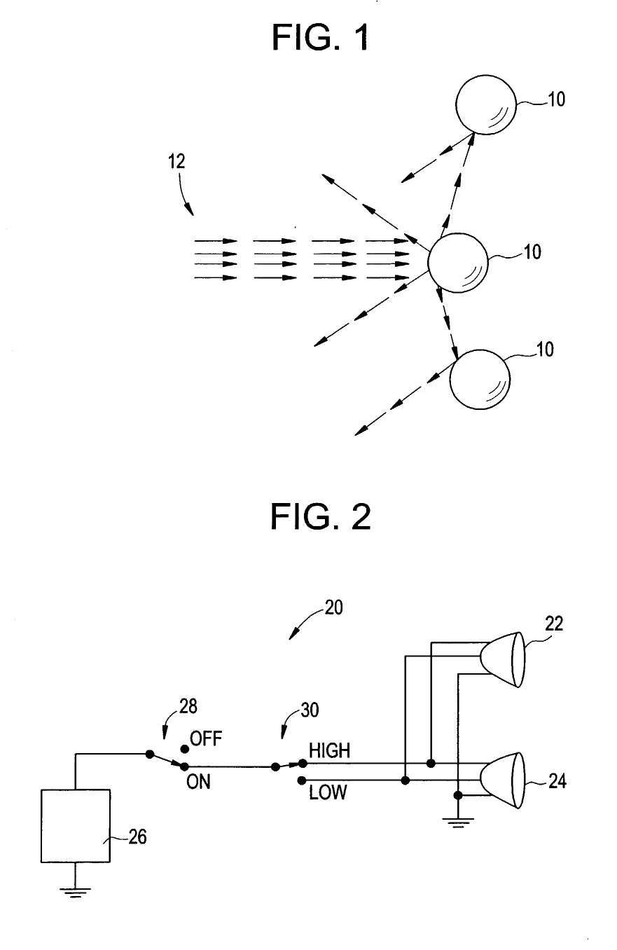

FIG. 1 shows a schematic diagram of one possible explanation of the reaction of light rays incident upon spheres of water in a moisture-laden atmosphere. The moisture-laden atmosphere includes spheres of water 10 upon which light rays 12 impact. The light rays 12 impact the surface of the water spheres 10 and are generally reflected back in the direction of the source of the light rays 12. The larger the number of water spheres 10 in the atmosphere, the more the light rays 12 are reflected back toward the source of the light.

FIG. 2 shows a schematic of a conventional headlamp system 20. The headlamp system 20 includes a driver side headlamp 22 and a passenger side headlamp 24. The system 20 also includes a power source such as a battery 26, an on/off switch 28 and a high/low switch 30. The headlamp system 20 is shown in a configuration where the headlamps are in the high beam configuration. Drivers typically use the high beam configuration in areas of reduced visibility to project a large amount of illumination in front of the vehicle. However, in a heavily moisture laden atmosphere, this additional degree of illumination can actually reduce the visibility of the driver because of the lack of penetration of the illumination through the moisture laden atmosphere and the degree that the illumination is reflected back into the driver's line of sight as explained in reference to FIG. 1.

The present invention reduces the degree of illumination that is generally aligned with a driver's line of sight. One embodiment of the present invention provides a lower amount of illumination from the driver side of the vehicle to maintain the visibility of the vehicle to oncoming drivers while still maintaining the amount of illumination from the passenger side headlamp.

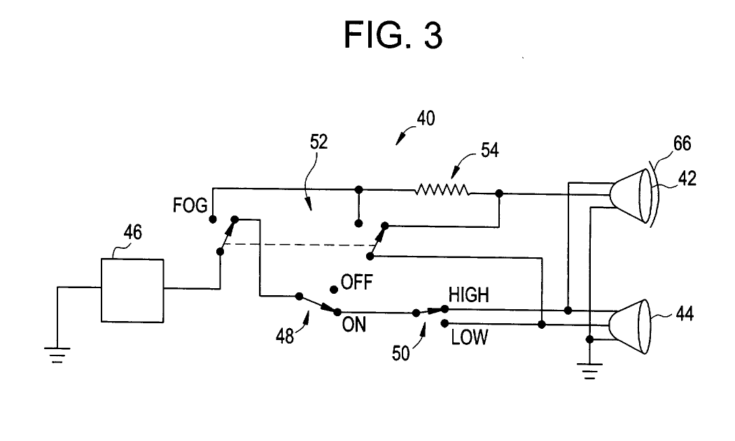

FIG. 3 shows a schematic of a headlamp system 40 in accordance with one embodiment of the present invention. The headlamp system 40 includes a driver side headlamp 42, a passenger side headlamp 44, a power supply or battery 46, an on/off switch 48, and a high/low beam switch 50 similar to the headlamp system 20 of FIG. 2. The headlamp system 40 also includes a double pole/double throw switch 52 and a resistor 54. FIG. 3 shows a configuration of the headlamp system 40 such that the high beams of both headlamps 42 and 44 are illuminated. If a user of the headlamp system 40 switches the switch 52 to the fog position, then power is supplied to the low beam of the driver side headlamp 42 and the low beam of the passenger side headlamp 44. However, because a resistor 54 is in line with the circuit of the low beam system of the driver side headlamp 42 a reduced amount of current is delivered to the driver side headlamp 42. Therefore, the driver side headlamp 42 delivers a reduced amount of illumination in comparison with the passenger side headlamp 44. The switch 52 overrides the high/low switch 50 to prevent inadvertent catastrophic use of the high beams that would disable the system 40.

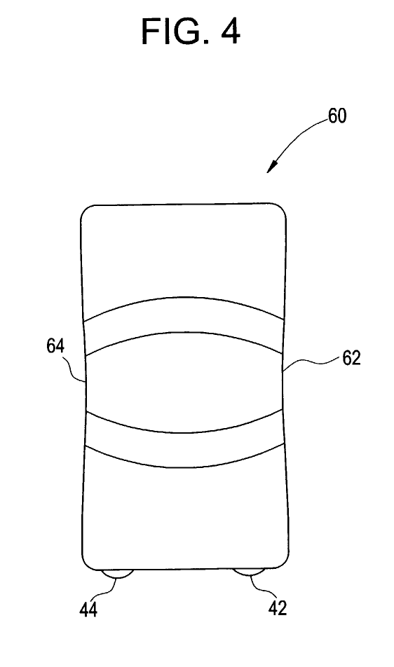

FIG. 4 shows an overhead schematic view of a vehicle incorporating an exemplary embodiment of the headlamp system in accordance with the invention. The vehicle 60 includes a drivers side 62 and a passenger side 64. FIG. 4 shows an example of the relative positions of the driver side headlamp 42 and the passenger side headlamp 44. As per convention, a driver (not shown) sits closer to on the drivers side 62 of the vehicle, thus, the driver sits closer to the driver side headlamp 42 than to the passenger side headlamp 44.

Those of ordinary skill in the art understand that many variations of the present invention may be provided, as long as a reduced amount of illumination is provided near the line of sight of a driver of a vehicle in comparison to the passenger side of the vehicle. For example, the on/off switch 48 of the headlamp system 40 of FIG. 3 may be positioned immediately after the battery 46. Also, one of ordinary skill in the art understands that a reduced amount of illumination may be obtained by many different methods such as, for example, shading the driver side headlamp 42. It is also understood that the amount of illumination of the passenger side headlamp 44 may be increased and still form a part of the present invention.

Another embodiment of the invention, not shown, may include a kit that may be retrofitted to an existing vehicle to provide the capability of reducing the illumination of the driver side headlamp 42. For example, as shown in FIG. 3 the headlamp system may incorporate a translateral cover 66 which reduces the illumination from the driver side headlamp 42. A retrofit kit for after-market applications may include a double throw switch as shown in FIG. 3 along with a resistor or other voltage line device that leads to the driver side headlamp. Such a system could easily be retrofitted into an existing headlamp system at a very low cost and would require a minimal amount of time for installation.

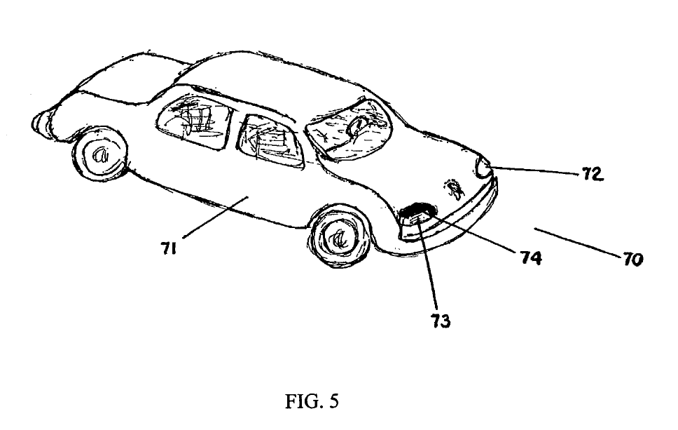

FIGS. 5-8 show other embodiments of a headlamp system 70 for a motor vehicle 71 in accordance with the invention. The system 70 includes a driver-side headlamp 72 that emits a beam of illuminating light, a retractable passenger-side headlamp 73 that emits a beam of illuminating light, and a fixed shield 74 for use in combination with the passenger-side headlamp 72 for increasing the intensity of illumination of the headlamp system 70 when the vehicle 71 is operated in reduced visibility conditions. It should be noted that the driver-side headlamp 72 and the retractable passenger-side headlamp 73 may be of the type in the previously-described embodiments of the invention.

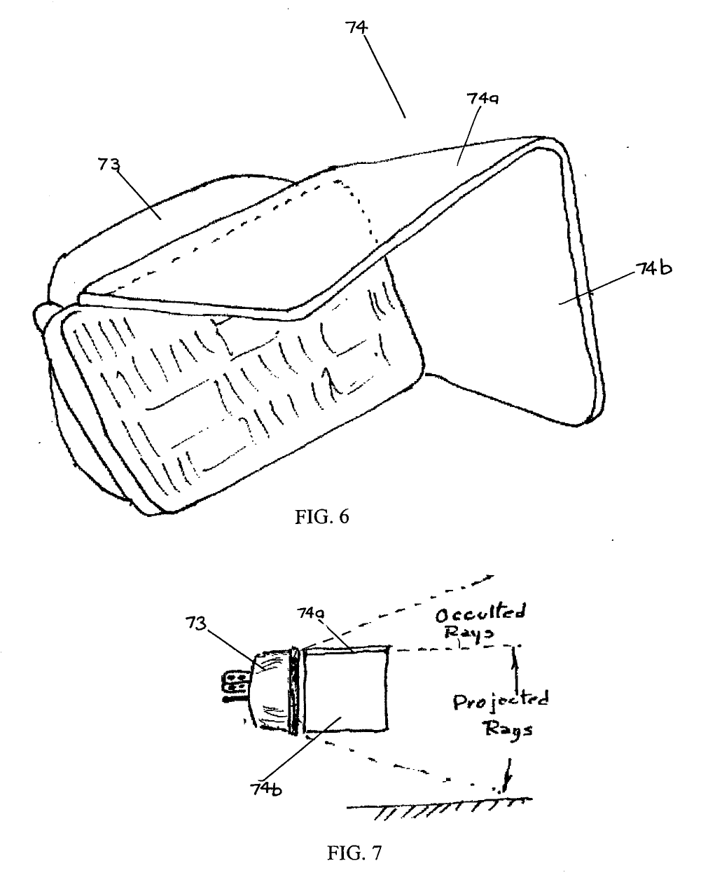

As shown in FIGS. 6 and 7, the shield 74 is fixedly mounted to the body of the vehicle 71 by a mounting mechanism such as a bracket 74c in a manner so as to maximize the desired light distribution emitted by the headlamp 73. The shield 74 has an L-shape configuration including a generally planar horizontally-extending shield section 74a that redirects a light beam emitted by the headlamp 73 downwardly towards the road surface and in front of the vehicle 71 to increase the intensity of illumination projected in front of the vehicle 71. Specifically, the beam of light emitted from the passenger-side headlamp 73 that are directed upward into an area directly in front of the passenger are instead directed downward towards the surface of the road in order to increase the driver's forward vision.

A generally planar vertically-extending shield section 74b increases the overall intensity of illumination of the beam of illuminating light emitted by the headlamp 73 by redirecting or deflecting a portion of the beam of illuminating light away from the driver-side of the vehicle 71 and towards the side of the road surface. While each shield section 73a, 73b is shown having a generally planar shape, they may take any shape or configuration necessary to maximize the desired light distribution emitted from the headlamp 73.

Each shield section 74a, 74b may be composed of a light-weight, yet robust polymeric, metallic or composite material. It is also preferable that the outer surface of the shield sections 74a, 74b be adaptable for reflecting the beam of illuminating light produced by the headlamp 73. In this regard, the outer surfaces of the shield 74 may be coated with an opaque-type material, or the entire shield section 74a, 74b itself can be composed of an opaque-type material.

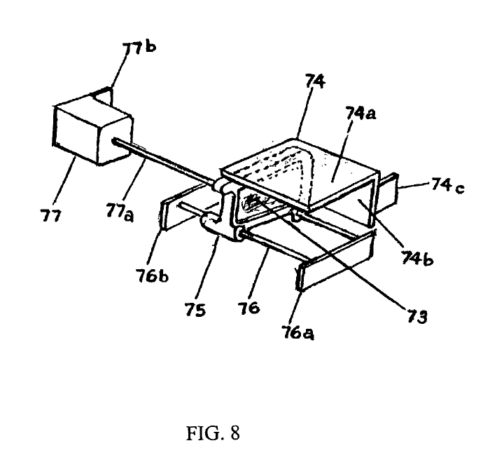

The passenger-side headlamp 73 is mounted so as to be selectively moveable, i.e., retractable, between a first position recessing into the body of the vehicle 71 and a second position projecting in front of the body of the vehicle 71. As shown in FIG. 8, the headlamp 73 may be mounted for linear movement relative to the vehicle 71 using a carrier mechanism which includes a carrier frame 75 for supporting the headlamp 73, the carrier frame 75 being supported for movement along a pair of linear guide rods 76, 77a which are mounted to the vehicle 71 by mounting brackets 76a. A control device 77 is provided for selectively placing the headlamp 73 between the first and second positions by moving the carrier frame 75 along guide rods 76, 77a. The control device 77 is mounted to the body of the vehicle 71 using a bracket 77b and may take the form of a solenoid, a vacuum cylinder, a motorized rack or a lead screw mechanism.

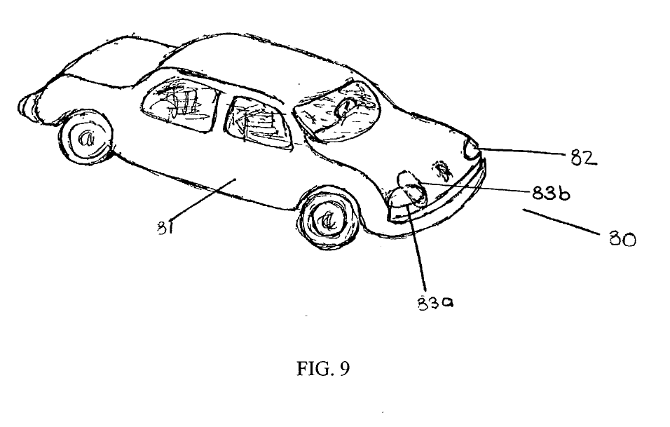

FIG. 9 shows another embodiment of a multiple headlamp system 80 for a motor vehicle 81 that provides a driver of the vehicle 81 with increased visibility when driving during moisture-laden conditions. The headlamp system 80 includes a conventional driver-side headlamp 82 of the type previously described. The driver-side headlamp 82 emits a substantially horizontal geometric beam pattern. The passenger-side headlamp 83 is mounted so as to be reoriented between a first position 83a permitting the headlamp 83 to emit a substantially horizontal geometric beam pattern and a second position 83b permitting the headlamp 83 to emit a substantially vertical geometric beam pattern. In other words, the position of the passenger-side headlamp 83 may be selectively reoriented so as to change the pattern of the beam of illuminating light by changing the angular position of the headlamp 83 relative to the body of the motor vehicle 81.

Moreover, the passenger-side headlamp 83 may also be mounted so as to be selectively moveable, i.e., retractable, between a third position in which it is recessed into the body of the vehicle 81 and a fourth position in which it projects in front of the body of the vehicle 81. The passenger-side headlamp 83 may be mounted for movement between the first and second positions and third and fourth positions by way of the carrier mechanism shown in FIG. 8. The passenger-side headlamp 83 may also be provided with a fixed shield of the type mentioned in the previous embodiment.

Although this invention has been described in conjunction with the specific embodiments outlined above, it is evident that many alternatives, modifications and variations are apparent to those who are skilled in the art. Accordingly, the embodiments of the invention set forth above are intended to be illustrative and not limiting. Various changes may be made without departing from the spirit and scope of the invention.

What is claimed is:

1. A headlamp system for a motor vehicle for providing increased visibility to a driver of the vehicle when the vehicle is in moisture-laden atmosphere, the system comprising:
a pair of headlamps adapted to produce respective beams of illuminating light; and
a shield mounted for placement adjacent to one of the pair of headlamps, said shield being adapted to deflect at least a portion of the beam of illuminating light emitted by said pair of headlamps,
wherein said one of said pair of headlamps is selectively movable between a first position in which it is recessed into the body of the vehicle and a second position in which it projects in front of the body of the vehicle.

2. The headlamp system of claim 1, wherein said pair of headlamps comprises a driver-side headlamp and a passenger-side headlamp, and said shield is mounted adjacent to said passenger-side headlamp.

3. The headlamp system of claim 2, wherein said shield comprises a horizontally-extending shield section that redirects a portion of the illuminating light beam downwardly in front of the vehicle and a vertically-extending shield section that redirects a portion in front of the vehicle and away from the driver-side of the vehicle.

4. The headlamp system of claim 1, further comprising a drive mechanism for moving said passenger-side headlamp between said first position and said second position.

5. The headlamp system of claim 4, wherein said drive mechanism comprises a carrier frame for supporting said passenger-side headlamp, a pair of guide rods which permit the carrier frame move linearly, and a control device for selectively moving the carrier frame.

6. The headlamp system of claim 5, wherein said control device comprises one selected from the group consisting of a solenoid, a vacuum cylinder, a motorized rack and a lead screw mechanism.

7. A headlamp system for a motor vehicle for providing increased visibility to a driver of the vehicle when the vehicle is in moisture-laden atmosphere, the system comprising:
a first headlamp adapted to emit a beam of illuminating light in a first geometric pattern; and
a second headlamp selectively movable between a first position that emits a beam of illuminating light in said first geometric pattern and a second position that emits a beam of illuminating light in a second geometric pattern.

8. The headlamp system of claim 7, wherein said first geometric pattern is a substantially horizontal geometric pattern and said second geometric pattern is a substantially vertical geometric pattern.

9. The headlamp system of claim 8, wherein said first headlamp is positioned on a driver-side of the vehicle and said second headlamp is positioned on a passenger-side of the vehicle.

10. The headlamp system of claim 9, wherein said second headlamp is selectively movable between a third position in which it is recessed into the body of the vehicle and a fourth position in which it projects in front of the body of the vehicle.

11. The headlamp system of claim 10, further comprising a shield mounted for placement adjacent to said second headlamp for to deflect at least a portion of the beam of illuminating light emitted by said second headlamp.

12. The headlamp system of claim 7, wherein said second headlamp is selectively movable between a third position in which it is recessed into the body of the vehicle and a fourth position in which it projects in front of the body of the vehicle.
